(19) United States
(12) Patent Application Publication
(10) Pub. No.: US 2013/0277454 A1
(43) Pub. Date: Oct. 24, 2013

(54) AIRCRAFT PROPULSION ASSEMBLY

(71) Applicants: AIRCELLE, (US); Snecma, (US)

(72) Inventors: Herve Hurlin, Igny (FR); Nicolas Dezeustre, Le Havre (FR); Wouter Balk, Melun (FR); Francois Gallet, Paris (FR)

(73) Assignees: Snecma, Paris (FR); AIRCELLE, Gonfreville L'Orcher (FR)

(21) Appl. No.: 13/856,038

(22) Filed: Apr. 3, 2013

Related U.S. Application Data
(63) Continuation of application No. PCT/FR2011/052298, filed on Oct. 3, 2011.

(30) Foreign Application Priority Data
Oct. 4, 2010 (FR) 10/57998

(51) Int. Cl. F02K 1/56

(52) U.S. Cl. CPC F02K 1/566
USPC 239/265.19

(57) ABSTRACT

The disclosure relates to an aircraft propulsion assembly including a nacelle having an intermediate housing and a front frame that is to be mounted downstream of an outer envelope of the intermediate housing. The front frame includes a deviation edge and an element forming a direct or indirect support for at least one flow deviation vanes, in particular, the deviation edge and the support-forming element are built into the outer envelope of the intermediate housing.

### CROSS-REFERENCE TO RELATED APPLICATIONS

This application is a continuation of International Application No. PCT/FR2011/052298 filed on Oct. 3, 2011, which claims the benefit of FR 10/57998, filed on Oct. 4, 2010. The disclosures of the above applications are incorporated herein by reference.

### FIELD

The present disclosure relates to an aircraft propulsion assembly.

### BACKGROUND

The statements in this section merely provide background information related to the present disclosure and may not constitute prior art.

An aircraft propulsion assembly is made up of a nacelle and a turbojet engine and is designed to be suspended from a fixed structure of the aircraft, for example under a wing or on the fuselage, by means of a suspension mast attached to the turbojet engine or the nacelle.

The turbojet engine typically includes a so-called “upstream” section comprising a fan provided with blades and a so-called “downstream” section housing a gas generator.

The blades of the fans are surrounded by a housing making it possible to mount the turbojet engine in the nacelle.

The nacelle has a generally tubular shape comprising an air intake upstream of the turbojet engine, a middle section designed to surround a fan of the turbojet engine, and a downstream section housing thrust reverser means and designed to surround the gas generator of the turbojet engine. A gas jet nozzle can extend the thrust reverser means in the downstream direction.

The thrust reverser means make it possible to improve the braking capacity of the aircraft by reorienting at least part of the thrust generated the turbojet engine forward. In reverse jet, the thrust reverser means obstruct the jet nozzle for the gases and orient the discharge flow from the engine toward the front of the nacelle, thereby generating a counter-thrust that is added to the braking of the wheels of the aircraft.

One common thrust reverser means structure comprises a cowl in which an opening is formed designed for the deviated flow which, in the direct thrust situation of the gases, is closed by the sliding cowl and, in the thrust reverser situation, is released by translating the sliding cowl in the downstream direction (relative to the gas flow direction), using movement cylinders, said movement cylinders being mounted on a front frame upstream of the opening.

In the cases of loads due to blade loss in the housing, strong front-to-back loads are generated on the reverser, those loads generally being reacted by the cylinders.

So as not to place all of these forces on the fastening points of the downstream section on the mast, the front frame is connected to the downstream end of the fan housing of the turbojet engine.

In a first alternative form of a thrust reverser structure called a “D-duct” structure, i.e., made in two parts articulated in the upper portion of the mast, the maintenance between the middle section of the nacelle and the front frame is done by a male or “vee blade” portion, generally supported by the front frame, cooperating with a female or “vee groove” portion, generally supported by a so-called intermediate housing of the middle section, the male part fixed on the front frame closing on the female part.

In a second alternative form of a reverser structure 100 called an “O-duct” structure illustrated in FIG. 3, i.e. having a downstream structure in the shape of a single-piece assembly with no breaks in structural continuity, an intermediate part 101 closes on two female parts 102 mounted on the intermediate housing 103 at the front frame 104, thereby providing the connection between the intermediate housing 103 and the front frame 104 of the reverser.

However, in this type of connection between the intermediate housing and the front frame, functional play exists between the two structures, which disrupts the flow of the air flow to a certain extent, and thereby affects the aerodynamic performance.

Such a configuration also has the drawback of making the nacelle heavier as well as having a significant bulk, this type of connection affecting the length of the nacelle.

Reducing the mass of the nacelle is thus desirable

Furthermore, during maintenance operations, in particular in an O-duct reverser structure, it is known to access the inside of the nacelle, and in particular the turbojet engine or an inner structure of the reverser, by separating the outer structure from the downstream section of the nacelle of the inner structure concentric thereto and translating the outer structure in the downstream direction so as to allow access to the engine body.

In one alternative, the movement cowl is translated toward the reverse jet position, then cascade vanes mounted on the outer fixed structure and more particularly the front frame are placed. The turbojet engine is then accessible either due to the presence of hatches situated on the inner structure or by lateral movement of the latter in the downstream direction.

One of the drawbacks of this configuration is the need to place and reassemble the vanes, which makes maintenance work tedious and time-consuming.

Another alternative consists of installing the vanes on a movable front frame. During maintenance operations, the front frame is separated from the intermediate housing and the assembly of the sliding cowl, front frame and cascade vanes is translated in the downstream direction of the nacelle to provide access to the engine body.

Irrespective of the selected maintenance access mode, such manipulations are time-consuming, difficult, and furthermore involve installing separating elements in areas that undergo major structural biases. Access to the engine is also tedious.

### SUMMARY

The present disclosure simplifies traditional arrangements, in particular so as not to make the nacelle heavier.

One aspect of the present disclosure is thus to provide an aircraft propulsion assembly that is easier to produce and having a lower mass.

Parallel to this advantage, another aspect of the present disclosure is to propose an aircraft propulsion assembly that is easy to implement and use during maintenance operations.

It is also desirable to improve the aerodynamic performance of aircraft propulsion assemblies.

To that end, the disclosure proposes an aircraft propulsion assembly comprising at least one nacelle comprising at least one intermediate housing and one front frame designed to be mounted downstream of an outer shroud of said intermediate housing, said front frame comprising a deviation edge and an element forming a direct or indirect support for at least one flow deviation means, characterized in that the deviation edge and the support-forming element are integrated into the outer shroud of the intermediate housing.

Owing to the present disclosure, the interface between the front frame and the intermediate housing is simplified inasmuch as any disassemblable connection is eliminated between those two elements.

Furthermore, the decrease in the number of parts at that interface makes it possible to reduce the mass of the nacelle and the associated production costs, as well as to reduce the length thereof.

Furthermore, any play is reduced between the front frame and the intermediate housing, favoring better aerodynamic performance.

According to other features of the disclosure, the assembly according to the disclosure includes one or more of the following optional features considered alone or according to all possible combinations:
the outer shroud of the intermediate housing, a torsion box of the front frame or the deviation edge provided with radial ribs are formed in a single piece;
the entire front frame is integrated into the outer shroud of the intermediate housing, with or without being in a single piece;
the deviation edge and said support-forming element for the front frame and the outer shroud of the intermediate housing form a single structural element, which offers the advantage of limiting the number of assembly operations to be performed during assembly of the nacelle;
the assembly also comprises a turbojet engine housed in the nacelle, the turbojet engine comprising a fan surrounded by a housing, said fan housing and an air intake structure of the nacelle with a fan housing alone being integrated into the outer shroud of the intermediate housing with or without being in a single piece, further limiting the mass of the nacelle;
the intermediate housing also comprising a hub and outlet guide vanes and optionally radial connecting arms connecting the hub to the outer shroud, the hub and/or the outlet guide vanes and/or the arms are integrated into the outer shroud of the intermediate housing, with or without being in a single piece;

the deviation edge, said support-forming element and the outer shroud of the intermediate housing are made from a composite material, further lightening the nacelle and facilitating the production of such parts;
at least one part of the flow deviation means is detachable from the front frame and translatable independently therefrom during a maintenance operation of said assembly, this offering the advantage of limiting any placement of the deviation means during maintenance operations and accelerating those operations;
the flow deviation means and the front frame comprise complementary locking/unlocking means capable of engaging the flow deviation means with the front frame in reverse jet and detaching the flow deviation means from the front frame during maintenance of said assembly, thereby favoring an optimal connection between the front frame and the deviation means in reverse jet in particular, and easily detachable during maintenance operations;
the assembly comprises, downstream of the front frame, an outer cowl mounted translatable along a substantially longitudinal axis of the nacelle, said cowl being capable, once the flow deviation means are detached, of translating the flow deviation means during a maintenance operation;

This offers the advantage of simplifying the additional devices necessary for maintenance operations.

The assembly comprises one or more actuators designed to translate the cowl along a substantially longitudinal axis of the nacelle downstream of the front frame toward at least one reverse jet position, said cowl being capable of translating one or more actuators during a maintenance operation, this making it possible to offer greater access during maintenance of the assembly.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a partial diagrammatic illustration of an aircraft propulsion assembly;

FIG. 2 is a partial diagrammatic illustration of the connection of the front nacelle frame and an intermediate housing of the aircraft propulsion assembly of FIG. 1;

FIG. 3 is an illustration of the prior art in partial longitudinal cross-section of the nacelle comprising a downstream thrust reverser structure having a reverser cowl in the closed position;

FIG. 4 is a partial longitudinal cross-sectional view of a nacelle comprising a downstream thrust reverser structure having a reverser cowl in the closed position according to a first form of the present disclosure;

FIG. 5 is a partial longitudinal cross-section of the nacelle comprising a downstream thrust reverser structure having a reverser cowl in the closed position according to a second form of the present disclosure;

FIGS. 6 and 7 are longitudinal cross-sectional views of the nacelle of FIG. 5 with its reverser cowl translated in the downstream direction, in the reverse jet position and in the maintenance position, respectively;

FIG. 8 is a longitudinal cross-sectional view of a first alternative form of a front frame of the downstream thrust reverser structure of FIGS. 3 to 6, and

FIG. 9 is a longitudinal cross-sectional view of a second alternative form of the front frame of the downstream thrust reverser structure of FIGS. 4 to 7.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In all of these figures, identical or similar references designate identical or similar members or sets of members.

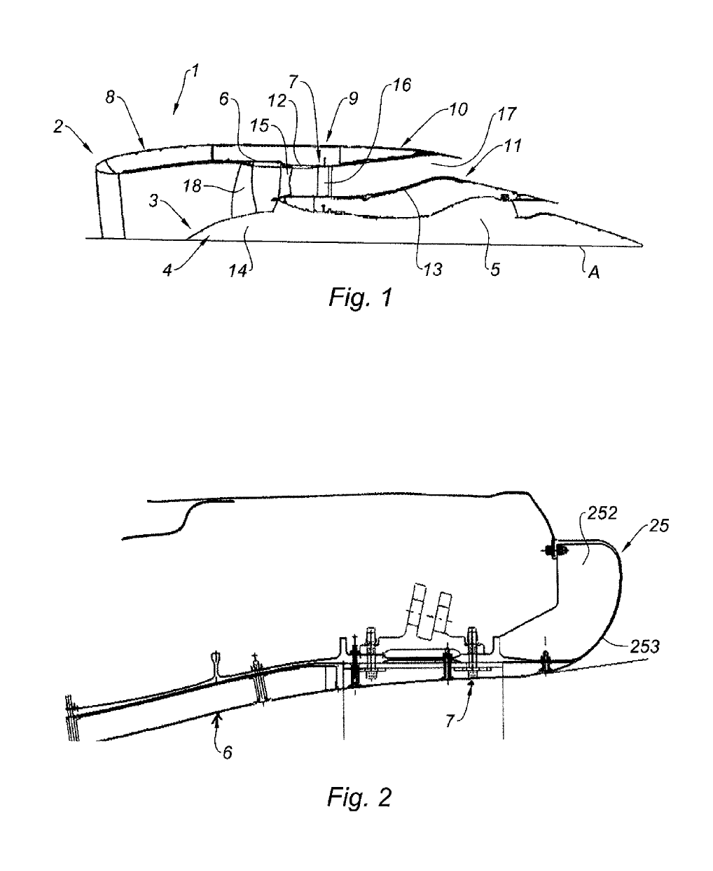

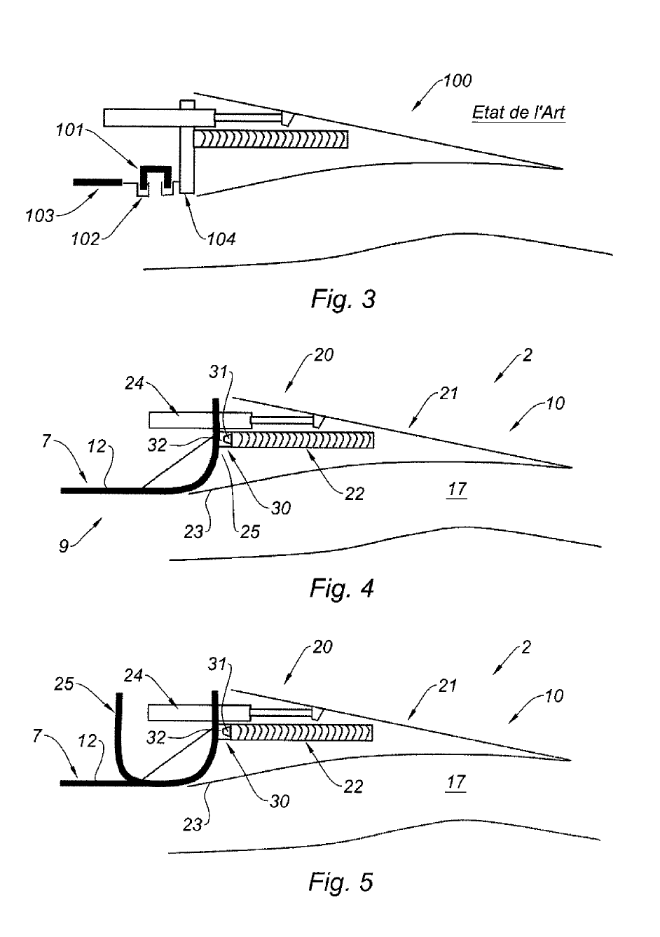

In reference to FIG. 1, an aircraft propulsion assembly 1 comprises a nacelle 2 surrounding a turbojet engine 3 that both have a primary longitudinal axis A.

As is known in itself, the turbojet engine 3 comprises a fan 4 delivering an annular flow of air with a primary flow that supplies the engine 5 driving the fan 4 and a secondary flow that is discharged into the atmosphere while providing a significant fraction of the thrust of the aircraft.

The fan 4 is contained in an outer housing 6 that channels the secondary flow the downstream direction, that flow passing through a wheel formed by an intermediate housing 7 belonging to a middle section of the nacelle 2.

As a reminder, the nacelle 2 typically comprises an upstream air intake structure 8, a metal structure 9 surrounding the blades 18 of the fan 4 of the turbojet engine 3, and a downstream structure 10 that can incorporate thrust reverser means 20.

This nacelle 2 also includes an inner structure 11 including a fairing 13 of the engine 5 downstream of the blades 18 of the fan 4 and which defines, with the downstream structure 10, an annular air tunnel 17 through which the secondary air flow is designed to circulate, as opposed to the hot primary flow created by the engine 5.

The fan 4 is rotatably mounted on a fixed hub 14 connected to the fan housing 6 by a plurality of stationary arms 16 that can transmit part of the forces between the engine 5 and its support.

Upstream of these fixed arms 16, between the rotor of the fan 4 and the arms 16, are outlet guide vanes (OGV) 15, making it possible to guide the secondary flow created by the fan 4 and optionally transmit forces toward the fan housing 6.

The intermediate housing 7 is thus a structural element that comprises the hub 14, an annular outer shroud 12, in contact with the secondary flow, and which supports the shroud of the fan housing 6 and the radial connecting arms 16 that connect the hub 14 to the outer shroud 12.

It may have a structural function inasmuch as the forces are transmitted using it, in particular the means for fastening the engine, if they are attached on that housing, to the structure of the aircraft in the front part are secured to the intermediate housing 7.

This intermediate housing 7 may either be made in a single unitary piece, or by a welded or bolted assembly of primary parts.

Furthermore, in all of FIGS. 4 to 7, the disclosure is illustrated by its implementation on cascade reverser means. Of course, the disclosure is applicable to other types of reversers in particular using other deviation means such as doors, for example.

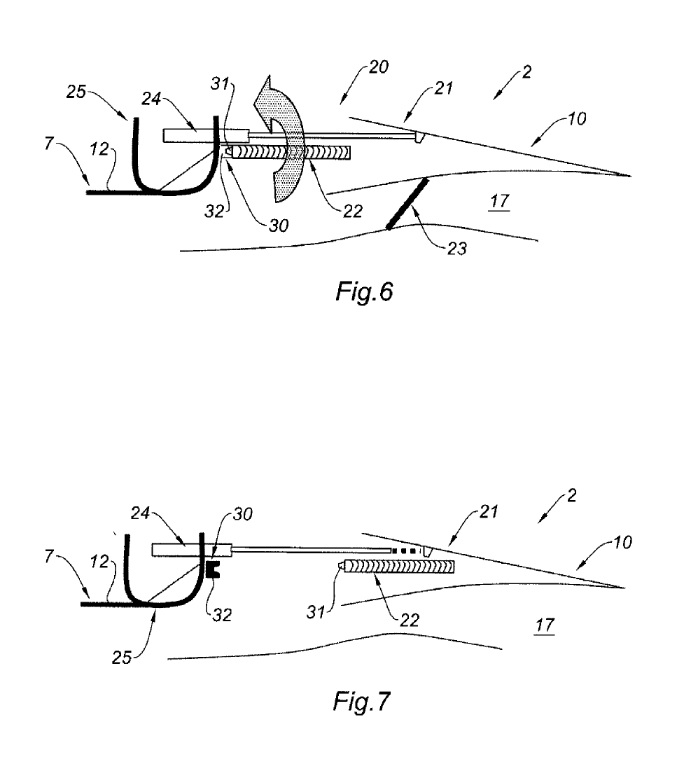

The thrust reverser means 20 here, for example, assume the form of a cowl 21 longitudinally translatable in the downstream direction of the nacelle 2 so as to free an opening in the outer downstream structure 10 of the nacelle 2 and expose the cascade vanes 22 capable of reorienting part of the secondary air flow generated by the turbojet engine with the front of the nacelle 2 through the opening thus freed, as illustrated in FIG. 6.

In FIG. 4, the reverser is in the closed position. In that case, the cowl 21 ensures the outer aerodynamic continuity of the nacelle 2 with the middle section 9 and covers the cascade vanes 22.

In one alternative form illustrated in FIG. 4, blocking flaps 23 ensure the aerodynamic continuity of the downstream section with the middle section 9. When the reverser is activated, these flaps 23 pivot to at least partially obstruct the tunnel 17 for the circulation of the secondary flow and help its reorientation through the cascade vanes 22 and the opening freed in the outer downstream structure 10 of the nacelle 2.

These blocking flaps are not always necessary, in particular, in certain configurations the withdrawal of the cowl 21 is sufficient to obstruct the tunnel.

The activation of the reverser is traditionally done by at least one actuator of the cylinder type 24 capable of translating the cowl 21.

Furthermore, the cascade vanes 22 are attached to the middle section 9 of the nacelle using the front frame 25 closing the thickness of the nacelle upstream of the cowl 21.

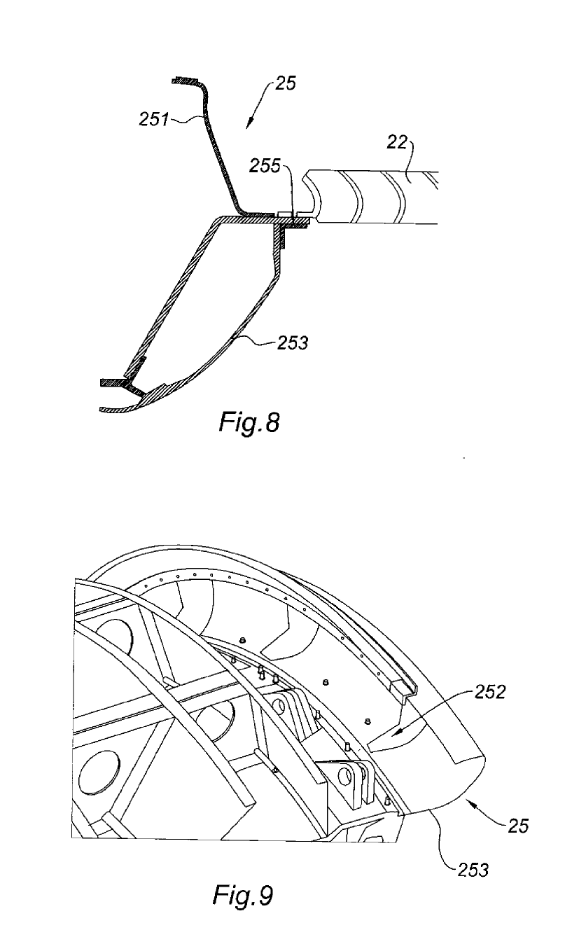

In one non-limiting form illustrated in FIG. 8, this front frame 25 comprises a front panel 251 designed to support the outer skin of the nacelle placed across from the outer shroud 12 of the intermediate housing 7, fixed to a torsion box 253.

In the given example, the shape of the back of the torsion box 253 ensures the aerodynamic function of the secondary flow deviation edge through the vanes 22.

An outer ring 255 allows the torsion box 253 and the cascade vanes 22 to be attached.

In another alternative form illustrated in FIGS. 2 and 9, the front frame 25 can be made using radial ribs 252 instead of a torsion box 253 to stiffen the structure.

These ribs 252 are placed in the concavity of an element 253 forming the deviation edge of the front frame 25 so as to ensure the aerodynamic line of the front frame 25.

According to the disclosure, as illustrated in FIGS. 2, 4 and 5, the intermediate housing 7 integrates, in its downstream portion, and more specifically downstream of the outer shroud 12, the deviation edge 253 and the support-forming elements for the cascade vanes 22.

“Integrated” means that the connection between the outer shroud 12 of the intermediate housing 7 and the front frame 25 is a complete non-disassemblable connection, i.e., any mobility is illuminated between the front frame 25 and the shroud 12.

This non-disassemblable connection between the front frame 25 and the shroud 12 can be of the riveting, gluing, forced fitting, welding type in non-limiting examples of the present disclosure.

Furthermore, the support-forming elements of the cascade vanes can be the outer ring 255 and the torsion box 253.

In a first alternative form, the outer shroud 12 of the intermediate housing 7, the torsion box 253 or the deviation edge assembly with its ribs 252 are formed in a single piece.

In a second alternative form, the entire front frame 25 is integrated into the outer shroud 12 of the intermediate housing 7, with or without being in a single piece.

In a third alternative form, the fan housing 6, alone or with the inner shroud of the air intake structure 8, is integrated into the outer shroud 12 of the intermediate housing 7.

In a fourth alternative form, the outlet guide vanes 15 and/or the hub 14 and/or the connecting arms and the engine suspension clevises, if they are situated on the outer shroud 12 of the intermediate housing of the intermediate housing 7 are integrated into the outer shroud assembly 12 of the intermediate housing 7 and front frame 25.

In a fifth alternative form, the members mentioned in the third and fourth alternatives are made from a single structural element.

Furthermore, the outer shroud 12 of the intermediate housing 7 and/or the front frame 25 can be made from a composite material.

The composite material can be chosen from among materials with a base of carbon fibers, glass fibers, aramid fibers, or a mixture of those materials with a resin.

This composite material may be obtained by draping pre-impregnated tissues or using a so-called LCM (Liquid Composite Molding) method in which the resin is mixed with dry carbon tissues or a woven or braided preform, if applicable.

Still in another form, the assembly of the aforementioned members integrated into the outer shroud 12 of the intermediate housing, i.e., the entire front frame 25, the hub 14, the OGVs 15 and the engine suspension clevises, are formed from a single structural element, for example made from a composite material.

This makes it possible to obtain a multifunctional part with an overall weight that is much lower than the set of parts it replaces, and not requiring any assembly operation.

The present disclosure allows savings in terms of structural simplicity as well as mass.

Furthermore, it is no longer necessary to have fasteners at the deviation edge 253 of the front frame 25 of the disclosure, such that pressure losses are decreased.

Furthermore, in reference to FIGS. 4 to 7, the actuating cylinder(s) 24 of the cowl 21 and the cascade vanes 22 are supported on the assembly formed by the front frame 25 and the outer shroud 12 of the intermediate housing 7 according to the disclosure.

Advantageously, the cascade vanes 22 can be connected to the front frame 25 detachably using locking/unlocking means that make it possible to disengage said vanes 22 from the front frame 25 and the middle section 9 and allow them to be translated in the downstream direction independently of the front frame 25.

In this way, the fixed front frame 25 and the removable cascade vanes 22 are attached in an operating configuration of the reverser, in the reverse jet phase when the cowl 21 slides in the downstream direction of the nacelle 2 and the reverser flaps 23 obstruct the tunnel 17, as illustrated in FIG. 6, and in flight phases.

They can be separated, during the maintenance operation, to allow the vanes 22 to be translated with the cowl 21 in the downstream direction of the nacelle 2 as far as a maintenance configuration, in which access is thus opened to the engine 5 and the inner structure of the reverser 11, as illustrated in FIG. 7.

Thus, in this FIG. 7, one can see that the assembly of the front frame 22 and the intermediate housing 7 forms a fixed assembly that is not movable in the maintenance position while the cascade vanes 22 and the cowl 21 form a unitary moving assembly movable in that maintenance position.

The locking/unlocking means 30 between the cascade vanes 22 and the front frame 25 may be of any type.

In one alternative form, the locking/unlocking means 30 comprise at least one pair of male 31 and female 32 connectors, one secured to the front frame 25/outer shroud 12 assembly and the other to the cascade vanes 22.

The connectors are arranged such that they cooperate during flight phases and reverse jet phases (see FIGS. 4 to 6), securing the cascade vanes 22 with the front frame 25/outer shroud of the housing 7 assembly and detached during maintenance operations illustrated in FIG. 7 to translate the assembly formed by the cowl 21 and the deviation means 22.

The propulsion assembly 1 according to the disclosure, and more specifically the first reverser, is implemented as follows.

During thrust reversal, illustrated in FIG. 6, the cowl 21 moves from the closed position, where it ensures the aerodynamic continuity with the middle section 9 of the nacelle, to an open position downstream of the nacelle 2, so as to expose the cascade vanes 22 and deviate part of the secondary air flow through those vanes 22.

Furthermore, the reverser flaps 23 also move during the travel of the cowl 21 and deploy in the cold flow tunnel 17.

During a maintenance operation, the locking means 30 between the front frame 22/outer shroud 12 assembly of the intermediate housing 7 and the cascade vanes 22 are first disengaged.

In reference to FIG. 7, once these elements are detached, the assembly formed by the cowl 21 and the cascade vanes 22 can be translated in the downstream direction of the nacelle 2 from the closed position of the cowl 21 to a maintenance position, either using the actuating cylinders 24 of the cowl 21 or using any other suitable means.

The front frame 22/outer shroud 12 assembly of the intermediate housing 7 remains stationary during this movement.

In a first alternative form, the same is true for the actuating cylinders, which remain stationary.

However, in a second alternative form, the cylinders 24 can be translatable toward the maintenance position and thus move simultaneously with the cowl 21 and the cascade vanes 22.

The movement of the cylinders 24 offers the advantage of not hindering access to the engine 5 of the turbojet engine 3.

Once the various movements are complete, an opening is then freed, which allows any person in particular to access the inner fixed structure 11 of the nacelle 2 or the body of the engine 5.

It should be noted that the aforementioned maintenance position of the cowl 21 can correspond to the reverse jet position of the cowl 21 or a position downstream of the reverse jet position of the cowl 21.

In the latter case, additional withdrawal of the cowl 21 may be made possible by an overtravel of the cylinders 24 or by suitable means for disconnecting cylinders 24 from the cowl and can slide the cowl 21 using any suitable means.

Of course, the present disclosure is in no way limited to the form described and shown, which are provided as simple examples.

What is claimed is:

1. An aircraft propulsion assembly comprising at least one nacelle having a turbojet engine, said nacelle comprising a middle section provided with an intermediate housing and a downstream section comprising a thrust reverser device provided with at least one of the flow cascade vanes, and a front frame designed to be mounted downstream of an outer shroud of said intermediate housing, said front frame comprising a flow deviation edge and at least one element forming a direct or indirect support for the flow deviation vanes, characterized in that the flow deviation edge and the element supporting the flow cascade vanes are integrated into the outer shroud of the intermediate housing.

2. The assembly according to claim 1, characterized in that the outer shroud of the intermediate housing, a torsion box of the front frame or the deviation edge provided with radial ribs are formed in a single piece.

3. The assembly according to claim 1, characterized in that the entire front frame is integrated into the outer shroud of the intermediate housing, with or without being in a single piece.

4. The assembly according to claim 1, characterized in that the deviation edge and said support-forming element for the front frame and the outer shroud of the intermediate housing form a single structural element.

5. The assembly according to claim 1, characterized in that it also comprises a turbojet engine housed in the nacelle, the turbojet engine comprising a fan surrounded by a housing, said fan housing and an air intake structure of the nacelle with a fan housing alone being integrated into the outer shroud of the intermediate housing with or without being in a single piece.

6. The assembly according to claim 1, characterized in that the intermediate housing also comprising a hub and outlet guide vanes and optionally radial connecting arms connecting the hub to the outer shroud, the hub and/or the outlet guide vanes and/or the arms are integrated into the outer shroud of the intermediate housing, with or without being in a single piece.

7. The assembly according to claim 1, characterized in that the deviation edge, said support-forming element and the outer shroud of the intermediate housing are made from a composite material.

8. The assembly according to claim 1, characterized in that at least one part of the flow deviation means is detachable from the front frame and translatable independently therefrom during a maintenance operation of said assembly.

9. The assembly according to claim 8, characterized in that the flow deviation means and the front frame comprise complementary locking/unlocking means capable of engaging the flow deviation means with the front frame in reverse jet and detaching the flow deviation means from the front frame during maintenance of said assembly.

10. The assembly according to claim 8, characterized in that it comprises, downstream of the front frame, an outer cowl mounted translatable along a substantially longitudinal axis of the nacelle, said cowl being capable, once the front frame and the flow deviation means are detached, of translating the flow deviation means during a maintenance operation.

11. The assembly according to claim 10, characterized in that it comprises one or more actuators designed to translate the cowl along a substantially longitudinal axis of the nacelle downstream of the front frame toward at least one reverse jet position, said cowl being capable of translating one or more actuators during a maintenance operation.
